(19) United States
(12) Patent Application Publication
(10) Pub. No.: US 2024/0304020 A1
(43) Pub. Date: Sep. 12, 2024

(54) IMAGE ANALYSIS APPARATUS, IMAGE ANALYSIS SYSTEM, IMAGE ANALYSIS METHOD, AND NONTRANSITORY STORAGE MEDIUM

(71) Applicant: NEC Corporation, Minato-ku, Tokyo (JP)

(72) Inventors: Satoshi Yoshida, Tokyo (JP); Jianquan Liu, Tokyo (JP); Shoji Nishimura, Tokyo (JP)

(73) Assignee: NEC Corporation, Minato-ku, Tokyo (JP)

(21) Appl. No.: 18/273,136

(22) PCT Filed: Feb. 16, 2022
(86) PCT No.: PCT/JP2022/006213

§ 371 Date: Jul. 19, 2023

(30) Foreign Application Priority Data
Mar. 23, 2021 (JP) 2021-048550

(51) Int. Cl. G06V 40/10; G06T 7/73; G06V 10/40; G06V 10/74

(52) U.S. Cl. CPC G06V 40/10; G06T 7/74; G06V 10/40; G06V 10/761; G06T 2207/30196

(57) ABSTRACT

To accurately determine an identical person in a plurality of images continuous in time series, an image analysis apparatus 100 includes an image acquisition unit 102 that acquires a plurality of images continuous in time series, a detection unit 103 that detects a person and a pose of the person in each of the plurality of images, and a decision unit 104 that decides identity of persons detected in images different from each other by using the pose of the person detected by the detection unit 103.

### TECHNICAL FIELD

The present invention relates to an image analysis apparatus, an image analysis system, an image analysis method, and a program.

### BACKGROUND ART

There is a technique for tracking, from a plurality of images continuous in time series being captured by a camera and the like, movement of a person in the plurality of images.

For example, a match determination apparatus described in PTL 1 determines a selected feature value being selected from one or a plurality of feature values for an analysis target included in an analysis group, and evaluates whether analysis targets between a plurality of analysis groups match, based on a combination of the selected feature values between different analysis groups. Further, when the evaluation indicates that the analysis targets between the analysis groups match, it is determined that the analysis targets in each of the different analysis groups are determined as an identical target.

### RELATED DOCUMENT

### Patent Document

[PTL 1] International Publication No. WO2019/138983

### SUMMARY OF INVENTION

### Technical Problem

However, in the technique described in PTL 1, at occurrence of overlapping between persons, hiding a person behind an object such as a pillar, and the like in a part of a plurality of images, persons that are actually an identical target may not be able to be decided as identical before and after the occurrence.

The present invention has been made in view of the circumstance described above, and an object thereof is to provide an image analysis apparatus, an image analysis system, an image analysis method, and a program, being able to accurately determine an identical person in a plurality of images continuous in time series.

### Solution to Problem

In order to achieve the object described above, an image analysis apparatus according to a first aspect of the present invention includes:
an image acquisition means for acquiring a plurality of images continuous in time series;
a detection means for detecting a person and a pose of the person in each of the plurality of images; and
a decision means for deciding identity of persons detected in images different from each other by using the detected pose of the person.

An image analysis system according to a second aspect of the present invention includes:
one or a plurality of capturing means; and
the image analysis apparatus described above.

An image analysis method according to a third aspect of the present invention includes: by a computer acquiring a plurality of images continuous in time series;
detecting a person and a pose of the person in each of the plurality of images; and
deciding identity of persons between images different from each other by using the
detected pose of the person.

A program according to a fourth aspect of the present invention is a program for causing a computer to execute:
acquiring a plurality of images continuous in time series;
detecting a person and a pose of the person in each of the plurality of images; and
deciding identity of persons between images different from each other by using the detected pose of the person.

### Advantageous Effects of Invention

The present invention is able to accurately determine an identical person in a plurality of images continuous in time series.

### BRIEF DESCRIPTION OF THE DRAWINGS

FIG. 1 is a diagram illustrating a functional configuration example of an image analysis system according to one example embodiment of the present invention.

FIG. 2 is a diagram schematically illustrating an example of an image in which each of captured regions A1 to A2 is captured at each time of times T1 to T4.

FIG. 3 is a diagram illustrating a physical configuration example of the image analysis system according to one example embodiment.

FIG. 4 is a flowchart illustrating one example of image analysis processing according to one example embodiment of the present invention.

FIG. 5 is a flowchart illustrating one example of the image analysis processing according to one example embodiment of the present invention.

FIG. 6 is a diagram schematically illustrating an example of an image in which each of the captured regions A1 to A2 is captured at each time of times T5 to T8.

FIG. 7 is a flowchart illustrating details of detection processing illustrated in FIG. 4.

FIG. 8 is a flowchart illustrating details of grouping processing illustrated in FIG. 4.

FIG. 9 is a diagram illustrating, in an overlapping manner, the images at the times T1 to T6 in which the captured region A1 is captured.

FIG. 10 is a diagram illustrating an example in which regions of persons detected in the images at the times T1 to T6 in which the captured region A1 is captured are combined into a group, and a flow line is generated.

FIG. 11 is a flowchart illustrating details of coupling processing illustrated in FIG. 5.

FIG. 12 is a flowchart illustrating details of the coupling processing illustrated in FIG. 5.

FIG. 13 is a diagram illustrating an example in which disconnected flow lines illustrated in FIG. 10 are coupled.

FIG. 14 is a diagram illustrating an example in which regions of persons detected in the images at the times T1 to T8 in which the captured region A2 is captured are combined into a group, and a flow line is generated.

FIG. 15 is a diagram illustrating an example in which the flow lines in the different captured regions A1 and A2 are coupled.

### DESCRIPTION OF EMBODIMENTS

Hereinafter, one example embodiment of the present invention will be described with reference to drawings. The same element is provided with the same reference sign through all the drawings. Note that, in all of the drawings, a similar component has a similar reference sign, and description thereof will be appropriately omitted.

### <Configuration of Image Analysis System>

An image analysis system according to one example embodiment of the present invention performs processing of deciding identity of persons between images different from each other, based on a plurality of images continuous in time series, obtaining a flow line of the person, based on a result of the decision, and the like.

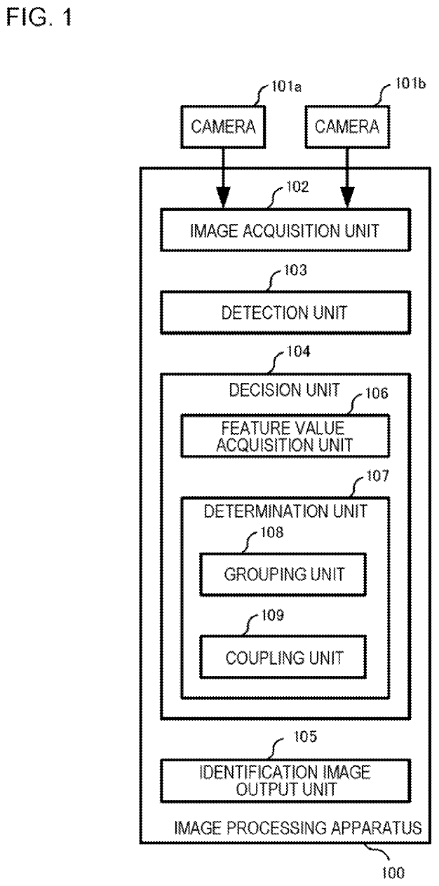

As illustrated in FIG. 1, the image analysis system includes two cameras 101a to 101b, and an image analysis apparatus 100. The image analysis apparatus 100 includes an image acquisition unit 102, a detection unit 103, a decision unit 104, and an identification image output unit 105.

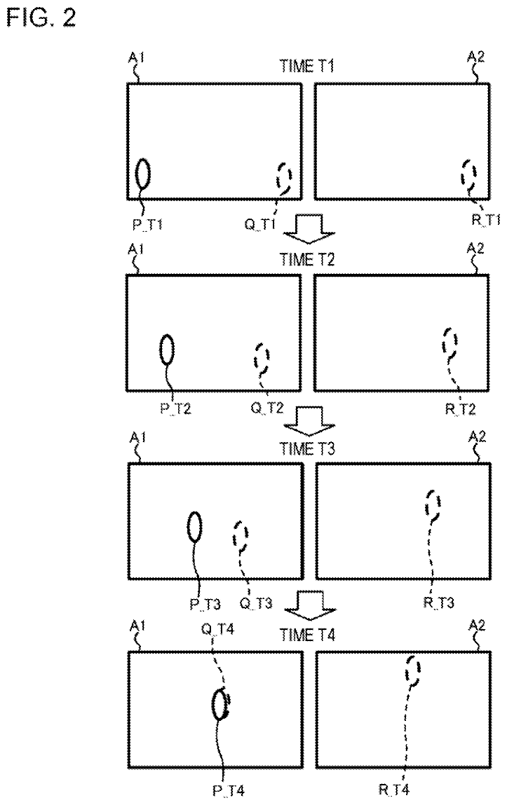

Each of the cameras 101a to 101b is provided at a station, in a structure, at a facility, on a road, and the like, and is one example of a capturing means for capturing a predetermined captured region. For example, as illustrated in FIG. 2, the cameras 101a to 101b generate image information indicating a plurality of two-dimensional images continuous in time series by capturing fixed captured regions A1 to A2.

FIG. 2 illustrates images of each of the captured regions A1 to A2 being captured at times T1 to T4. P_T1 to P_T4 indicated in the captured region A1 schematically illustrate a region of a person P being captured at each of the times T1 to T4. Q_T1 to Q_T4 indicated in the captured region A1 schematically illustrate a region of a person Q being captured at each of the times T1 to T4. R_T1 to R_T4 indicated in the captured region A2 schematically illustrate a region of a person R being captured at each of the times T1 to T4.

Note that, one or more cameras may be provided in the image analysis system.

FIG. 1 is referred again.

The image acquisition unit 102 acquires a plurality of images continuous in time series in which the captured regions A1 to A2 are captured. In the present example embodiment, the image acquisition unit 102 acquires image information generated by each of the cameras 101a to 101b from each of the cameras 101a to 11b via a network constituted in a wired manner, a wireless manner, or appropriately in combination of the manners.

The detection unit 103 detects a person and a pose of the person in each of the plurality of images acquired by the image acquisition unit 102.

Specifically, for example, the detection unit 103 detects a region of a person and a pose of the person in each image, based on image information about each of the plurality of images. A known technique may be used as a technique for detecting each of a region and a pose of a person from an image.

A pose of a person may be detected, based on a feature such as a joint of a person to be recognized, by using a skeleton estimation technique using machine learning. Examples of the skeleton estimation technique can include OpenPose described in “Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, P. 7291-7299”.

The decision unit 104 decides, by using the pose of the person detected by the detection unit 103, identity of persons detected between images different from each other.

Specifically, as illustrated in FIG. 1, the decision unit 104 includes a feature value acquisition unit 106 and a determination unit 107.

The feature value acquisition unit 106 obtains a pose feature value of the person by using the pose of the person detected by the detection unit 103.

The pose feature value is a value indicating a feature of a pose of a person, and is, for example, a feature value of a two-dimensional skeleton structure detected by the detection unit 103. The pose feature value may be a feature value of the entire skeleton structure, may be a feature value of a part of a skeleton structure, or may include a plurality of feature values as in each portion of a skeleton structure.

A method of calculating a pose feature value may be any method such as machine learning and normalization, and a minimum value and a maximum value may be obtained as normalization. As one example, the pose feature value is a feature value acquired by performing machine learning on a skeleton structure, a size of a skeleton structure from head to toe on an image, and the like. The size of a skeleton structure is a height in an up-down direction, an area, and the like of a skeleton region including the skeleton structure on an image. The up-down direction (a height direction or a vertical direction) is a direction (Y-axis direction) of up and down in an image, and is, for example, a direction perpendicular to the ground (reference surface). A left-right direction (a horizontal direction) is a direction (X-axis direction) of left and right in an image, and is, for example, a direction parallel to the ground.

The determination unit 107 determines an identical person from persons detected in the images different from each other, based on whether a similarity degree between the pose feature values obtained by the feature value acquisition unit 106 is equal to or more than a first reference value.

Herein, the first reference value is a value predetermined for a similarity degree between pose feature values, as a reference for deciding whether poses are similar.

When all of the following conditions A to C are satisfied, the determination unit 107 according to the present example embodiment decides that persons detected in images different from each other are an identical person. Further, when at least one of the conditions A to C is not satisfied, the determination unit 107 decides that persons detected in images different from each other are not an identical person.

Condition A: a similarity degree between pose feature values is equal to or more than the first reference value.

Condition B: an identical person is not present in an overlapping manner in terms of time.

Condition C: different persons are not present in an overlapping manner in terms of place.

Note that, one or both of the condition B and the condition C may not be included in a condition for determining an identical person.

More specifically, the determination unit 107 includes a grouping unit 108 and a coupling unit 109.

The grouping unit 108 decides whether persons detected in images different from each other are an identical person, based on the condition A to the condition C, as described above, and divides images of persons included in each of the plurality of images into groups in such a way that images of the persons decided as the identical person belong to the same group. In the grouping processing, for “images different from each other”, for example, images at adjacent capturing times may be successively selected along time series.

Then, the grouping unit 108 generates a flow line of each person included in the plurality of images by connecting image regions of persons belonging to the same group according to time series. The flow line is a line connecting predetermined places such as a center of gravity of an image of a person and a center of shoulders.

Note that, similarly to the coupling unit 109 described below, the grouping unit 108 may decide whether persons included in images different from each other are an identical person, based on the conditions A to G.

When a disconnected flow line is included in a flow line generated by the grouping unit 108, the coupling unit 109 couples the disconnected flow lines.

Herein, the disconnected flow line is a flow line including an end portion in the captured region A1 or A2.

When a person moves, the person normally enters the captured region A1 or A2 from the outside of the captured region A1 or A2, and then goes out of the captured region A1 or A2. Thus, both ends of many flow lines substantially match a boundary of the captured region A1 or A2. However, a disconnected flow line may be generated when persons overlap each other, when a person hides behind an object such as a pillar, and the like in an image.

The coupling unit 109 decides whether persons included in images being end portions of a flow line, i.e., images before and after the flow line becomes disconnected, and connects end portions of the disconnected flow lines when the coupling unit 109 decides that the persons are an identical person.

The coupling unit 109 according to the present example embodiment decides whether persons detected in images different from each other are an identical person, based on the condition A to the condition C described above and the following conditions D to G. In the coupling processing, for “images different from each other”, images before and after a flow line becomes disconnected may be selected.

Condition D: a capturing time interval between images before and after a flow line becomes disconnected falls within a predetermined period of time.

Condition E: a distance between persons detected in images before and after a flow line becomes disconnected falls within a predetermined distance.

Condition F: a difference in orientation between persons detected in images before and after a flow line becomes disconnected falls within a predetermined range.

Condition G: a similarity degree between image feature values of persons detected in images before and after a flow line becomes disconnected is equal to or more than a second reference value.

Herein, the capturing time interval between images is a time interval between times at which the images are captured. Images continuous in time series are often captured at a substantially fixed time interval such as every second N (N is an integer of 1 or more), for example, and thus a period of time (the predetermined period of time described above) predetermined for a capturing time interval may be defined by the number of images. Note that, the predetermined period of time may be defined by a time length and the like, for example.

For example, whether a distance between persons is a predetermined distance may be decided based on a distance (for example, the number of pixels) between image regions of persons in an image, or may be decided based on a distance between real spaces estimated from a distance between image regions of persons in an image.

An image feature value is a value indicating a feature of an image region of a person as an image, and is a feature value generated based on image information. The image feature value may be a feature value of the entire image of a person, may be a feature value of a part of the image, or may include a feature value of a plurality of portions such as a face, a trunk, and a leg. A method of calculating an image feature value may be any method such as machine learning and normalization, and a minimum value and a maximum value may be obtained as normalization. As one example, the image feature value is a degree of matching with average brightness of each color component, and a color pattern such as plaid and stripes, and the like.

The second reference value is a value predetermined for a similarity degree between image feature values, as a reference for deciding whether images are similar.

When all of the following conditions A to G are satisfied, the coupling unit 109 according to the present example embodiment decides that persons detected in images different from each other are an identical person. Further, when at least one of the conditions A to G is not satisfied, the coupling unit 109 decides that persons detected in images different from each other are not an identical person.

Note that, a part or the whole of the condition B to the condition G may not be included in a condition for coupling disconnected flow lines.

The identification image output unit 105 outputs identification image information based on a result of the decision by the decision unit 104. The identification image information is information including an image in which information (i.e., identification information for identifying an identical person) for identifying a person detected in each of a plurality of images is associated with the person.

A method of outputting image information by the identification image output unit 105 is, for example, display, transmission, and the like of the image information. In other words, the identification image output unit 105 may display an image on a display, and may transmit an image to another apparatus connected via a network constituted in a wired manner, a wireless manner, or appropriately in combination of the manners.

### <Physical Configuration of Image Analysis System>

Hereinafter, an example of a physical configuration of the image analysis system according to the present example embodiment will be described with reference to the drawings.

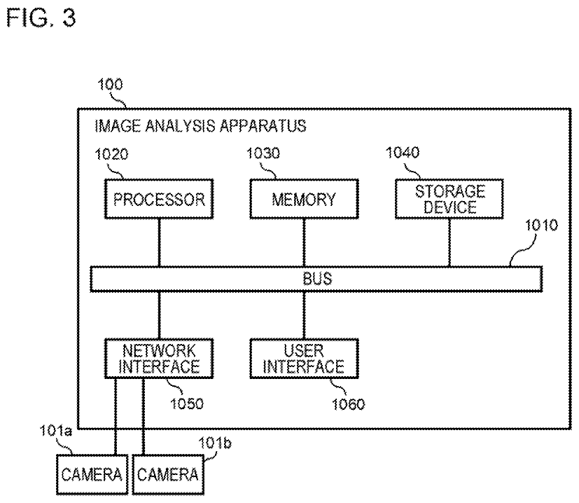

As illustrated in FIG. 3, the image analysis apparatus 100 physically includes a bus 1010, a processor 1020, a memory 1030, a storage device 1040, a network interface 1050, and a user interface 1060.

The bus 1010 is a data transmission path for allowing the processor 1020, the memory 1030, the storage device 1040, the network interface 1050, and the user interface 1060 to transmit and receive data with one another. However, a method of connecting the processor 1020 and the like to each other is not limited to bus connection.

The processor 1020 is a processor achieved by a central processing unit (CPU), a graphics processing unit (GPU), and the like.

The memory 1030 is a main storage apparatus achieved by a random access memory (RAM) and the like.

The storage device 1040 is an auxiliary storage apparatus achieved by a hard disk drive (HDD), a solid state drive (SSD), a memory card, a read only memory (ROM), or the like.

The storage device 1040 achieves a function of holding various types of information.

Further, the storage device 1040 stores a program module that achieves each functional unit (the image acquisition unit 102, the detection unit 103, the decision unit 104 (the feature value acquisition unit 106, the determination unit 107 (the grouping unit 108, the coupling unit 109)), the identification image output unit 105) of the image analysis apparatus 100. The processor 1020 reads each program module onto the memory 1030 and executes the program module, and each functional unit associated with the program module is achieved.

The network interface 1050 is an interface for connecting the image analysis apparatus 100 to a network constituted in a wired manner, a wireless manner, or combination of the manners. The image analysis apparatus 100 according to the present example embodiment communicates with the cameras 101a to 101b and the like by being connected to the network through the network interface 1050.

The user interface 1070 is an interface to which information is input from a user and an interface that presents information to a user, and includes, for example, a mouse, a keyboard, a touch sensor, and the like as an input means, a display (for example, a liquid crystal display and an organic EL display), and the like, for example.

In this way, a function of the image analysis apparatus 100 can be achieved by executing a software program by each of physical components in collaboration with each other. Thus, the present invention may be achieved as a software program (simply referred to as a “program”), and may be achieved as a non-transitory storage medium that stores the program.

### <Image Analysis Processing>

Hereinafter, image analysis processing according to one example embodiment of the present invention will be described with reference to the drawings.

The image analysis processing is processing of deciding identity of persons between images different from each other, based on a plurality of images continuous in time series being captured by the cameras 101a to 101b, obtaining a flow line of the person, based on a result of the decision, and the like.

The image analysis processing starts by indicating an image to be a processing target from a user, for example. The image being the processing target is indicated by a camera that performs capturing, and a capturing time including a start time and an end time of capturing, for example. In the present example embodiment, an example in which images captured at a start time T1 to an end time T8 by each of the cameras 101a to 101b are indicated as the image being the processing target will be described.

The image acquisition unit 102 acquires a plurality of images continuous in time series in which each of the captured regions A1 to A2 is captured by the cameras 101a to 101b (step S101).

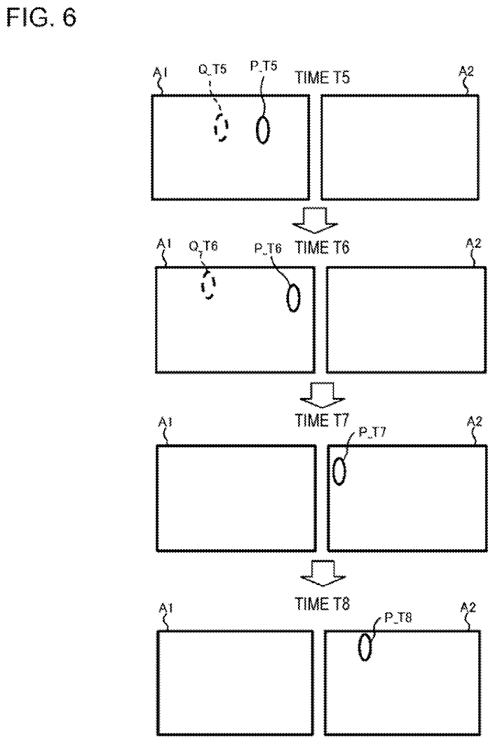

Specifically, for example, in step S101, the image acquisition unit 102 acquires, from each of the cameras 101a to 101b, image information indicating each of the images illustrated in FIGS. 2 and 6. The image information may include camera identification information for identifying the cameras 101a to 101b that perform capturing, and a capturing time.

FIGS. 2 and 6 are diagrams illustrating an example of the images captured at the start time T1 to the end time T8 by each of the cameras 101a to 101b. As described above, FIG. 2 illustrates the images of each of the captured regions A1 to A2 being captured at the times T1 to T4. FIG. 6 illustrates the images of each of the captured regions A1 to A2 being captured at the times T5 to T8.

In FIG. 6, P_T5 to P_T6 indicated in the captured region A1 schematically illustrate a region of the person P being captured at each of the times T5 to T6. Q_T5 to Q_T6 indicated in the captured region A1 schematically illustrate a region of the person Q being captured at each of the times T5 to T6. P_T7 to P_T8 indicated in the captured region A2 schematically illustrate a region of the person P being captured at each of the times T7 to T8.

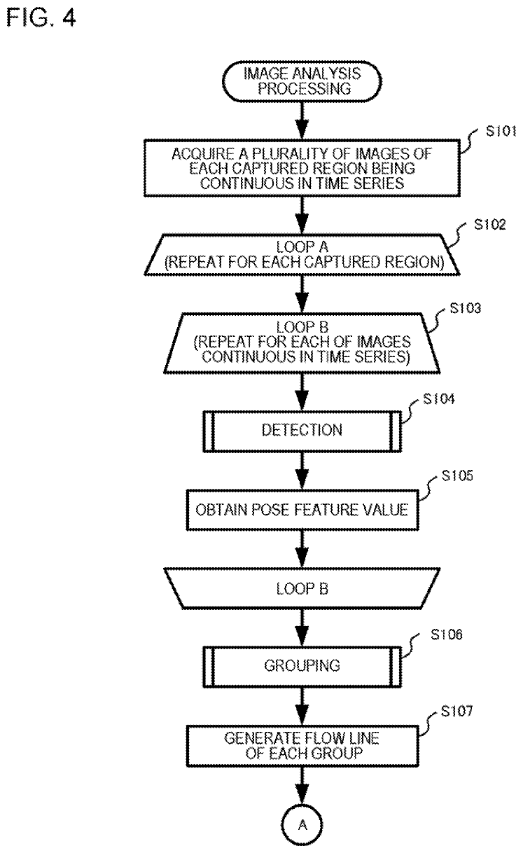

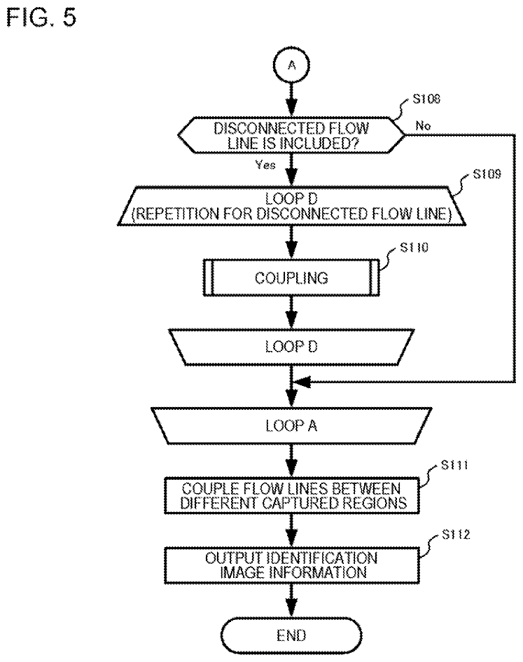

As illustrated in FIGS. 4 and 5, the detection unit 103 and the decision unit 104 repeatedly perform the processing in steps S103 to S110 on each of the captured regions A1 and A2 acquired in the step S101 (step S102; loop A).

Herein, whether each image is an image of a captured region of either the captured region A1 or A2 may be determined by referring to camera identification information of the image information acquired in the step S101. Hereinafter, an example in which processing is first performed on, as a target, each of the images at the times T1 to T8 in which the captured region A1 is captured will be described.

The detection unit 103 and the feature value acquisition unit 106 repeat the processing in the steps S104 to S105 on each of the images continuous in time series (step S103; loop B). Specifically, for example, the processing in the steps S104 to S105 is repeated in order for each of the images at the times T1 to T8 with the captured region A1 as a captured region being a processing target.

The detection unit 103 performs detection processing (step S104).

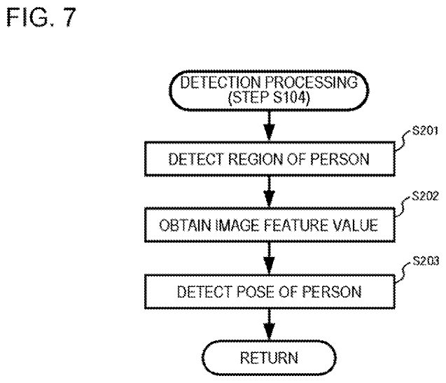

FIG. 7 is a flowchart illustrating details of the detection processing (step S104).

As illustrated in FIG. 7, the detection unit 103 detects a region of a person in each image (step S201). Specifically, for example, in a case of the image at the time T1 illustrated in an upper left image in FIG. 2, a region of the person P indicated by the ellipse P_T1 by a solid line and a region of the person Q indicated by the ellipse QT1 by a broken line are detected.

The detection unit 103 obtains an image feature value for each region of the person determined in the step S201 (step S202). Specifically, for example, an image feature value indicating a feature of the image of each region is obtained based on image information about the region of the person determined in the step S201.

The detection unit 103 detects a pose of the person for each region of the person determined in the step S201 (step S203).

Specifically, for example, with, as an input, an image of the region of the person determined in the step S201, a pose of the person is detected by estimating a state of a skeleton of the person by using a skeleton estimation model being learned by using machine learning. For example, in a case of the image at the time T1 illustrated in the upper left image in FIG. 2, a pose of the person P indicated by the ellipse P_T1 by the solid line and a pose of the person Q indicated by the ellipse Q_T1 by the broken line are detected. In this way, the detection unit 103 ends the detection processing (step S104), and the processing returns to the image analysis processing illustrated in FIG. 4.

As illustrated in FIG. 4, the feature value acquisition unit 106 obtains a pose feature value by using the pose of the person detected in the step S203 (step S105).

Specifically, for example, with, as an input, a pose of the person detected in the step S104, the feature value acquisition unit 106 outputs a pose feature value of the person by using a pose feature value computation model being learned by using machine learning. For example, in a case of the image at the time T1 illustrated in the upper left image in FIG. 2, a pose feature value of the person P indicated by the ellipse P_T1 by the solid line and a pose feature value of the person Q indicated by the ellipse Q_T1 by the broken line are obtained.

Note that, an image of the region of the person determined in the step S201 may be used together with a pose of the person for input information for obtaining a pose feature value.

Such processing in the steps S104 to S105 is repeated for each of the images at the times T1 to T8 being continuous in time series, in which the captured region A1 being a target for the processing in the loop A (step S102) is captured (step S103; loop B).

When the processing in the loop B (step S103) ends, the grouping unit 108 combines, into a group, images of persons detected in each of the images at the times T1 to T8 being continuous in time series, in which the captured region A1 being a target for the processing in the loop A (step S102) is captured (step S106).

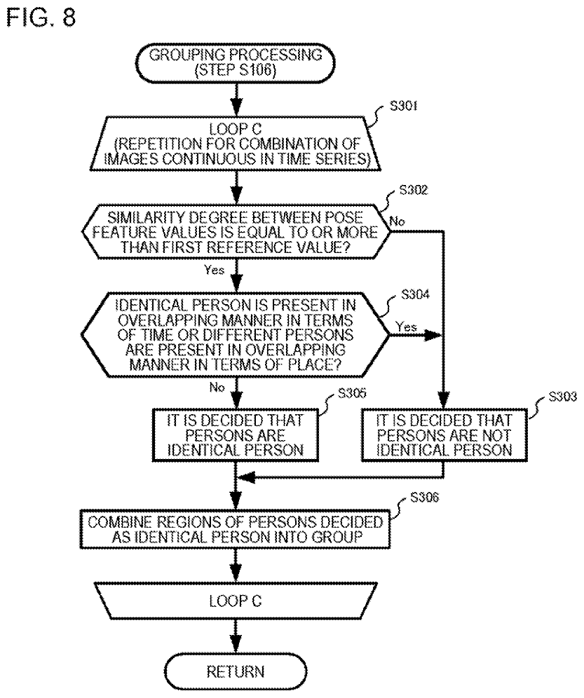

FIG. 8 is a flowchart illustrating details of the grouping processing (step S106).

The grouping unit 108 repeats the processing in steps S302 to S306 for a combination of images continuous in time series, in which the captured region A1 being a target for the processing in the loop A (step S102) is captured (loop C; step S301).

Specifically, for example, a combination of images that are to be a processing target in the loop C and are continuous in time series includes the images at the times T6 and T5, the images at the times T5 and T4, the images at the times T4 and T3, the images at the times T3 and T2, and the images at the times T2 and T1. In the loop C, for example, a combination of images to be a processing target may be selected in an order of time series. Hereinafter, an example in which a combination of images to be a processing target is selected from images later in terms of time, i.e., a combination of the images at the times T6 and T5 will be described.

Note that, since a person is not included in the images at the times T7 and T8 in which the captured region A1 is captured, the images at the times T7 and T8 may be excluded from a processing target of the loop C.

The grouping unit 108 decides whether a similarity degree between pose feature values of persons detected in images different from each other is equal to or more than the first reference value (step S302). The decision processing related to a pose feature value in the step S302 corresponds to a decision about whether the condition A described above is satisfied.

Specifically, for example, it is assumed that a combination of the images at the times T6 and T5 in which the captured region A1 is captured is a processing target. In this case, the grouping unit 108 obtains a similarity degree between pose feature values obtained in the step S105 for each combination of persons detected in the images at the times T6 and T5.

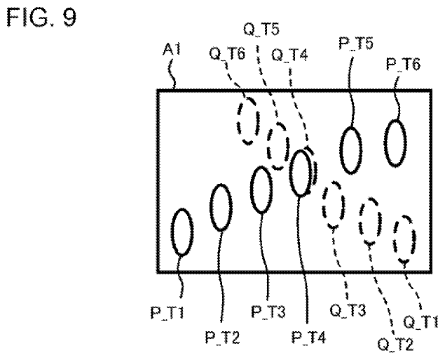

Herein, FIG. 9 is a diagram illustrating, in an overlapping manner, the images at the times T1 to T6 in which the captured region A1 is captured. In FIG. 9, persons detected in the images at the times T6 and T5 are persons in regions P_T6, P_T5, Q_T6, and Q_T5. The similarity degree is obtained for each of six combinations when two regions are extracted from the four regions. Specifically, the combinations in the example are combinations of the regions P_T6 and P_T5, P_T6 and Q_T6, P_T6 and Q_T5, P_T5 and Q_T6, P_T5 and Q_T5, and Q_T6 and Q_T5.

The similarity degree between pose feature values is, for example, a difference, a ratio, and the like of pose feature values. Then, the grouping unit 108 decides whether the similarity degree between the pose feature values is equal to or more than the first reference value by comparing the similarity degree with the first reference value.

When the grouping unit 108 decides that the similarity degree between the pose feature values is not equal to or more than the first reference value (step S302; No), the grouping unit 108 decides that the persons related to the pose feature values from which the similarity degree is obtained are not an identical person (step S303).

In general, a pose of a moving person rarely changes greatly in a short time, and a change in the pose often falls within a certain range. Thus, when a similarity degree between pose feature values of persons detected in images different from each other is less than the first reference value, it can be estimated that the persons are not an identical person. When a similarity degree between pose feature values of the persons is equal to or more than the first reference value, it can be estimated that the persons are an identical person.

For example, in a case of persons detected in the images at the times T6 and T5 in which the captured region A1 is captured, it is decided that persons indicated by the regions are not an identical person for four combinations among the six combinations described above. In the example, specifically, the combinations of the regions indicating the persons who are decided as not an identical person are the regions P_T6 and Q_T6, the regions P_T6 and Q_T5, the regions P_T5 and Q_T6, and the regions P_T5 and Q_T5.

When the grouping unit 108 decides that the similarity degree between the pose feature values is equal to or more than the first reference value (step S302; Yes), the grouping unit 108 decides whether an identical person is present in an overlapping manner in terms of time or different persons are present in an overlapping manner in terms of place (step S304). The decision processing related to overlapping of an identical person in the step S304 corresponds to a decision about whether the conditions B and C described above are satisfied.

For example, in a case of persons detected in the images at the times T6 and T5 in which the captured region A1 is captured, it is decided that the similarity degree between the pose feature values is equal to or more than the first reference value for the combinations of the regions P_T6 and P_T5 and the regions Q_T6 and Q_T5.

Since the regions P_T6 and P_T5 are included in the images at the different times T6 and T5, an identical person is not present in an overlapping manner in terms of time. Similarly, the regions Q_T6 and Q_T5 are included in the images at the different times T6 and T5, an identical person is not present in an overlapping manner in terms of time.

Further, the regions P_T6 and P_T5 do not overlap each other in terms of place, and the regions Q_T6 and Q_T5 also do not overlap each other in terms of place.

Thus, for the combinations of the regions P_T6 and P_T5 and the regions Q_T6 and Q_T5 in the example, it is decided that an identical person is not present in an overlapping manner in terms of time and different persons are not present in an overlapping manner in terms of place.

When the grouping unit 108 decides that an identical person is not present in an overlapping manner in terms of time and different persons are not present in an overlapping manner in terms of place (step S304; No), the grouping unit 108 decides that the persons indicated by the regions are an identical person (step S305).

For example, for the combinations of the regions P_T6 and P_T5 and the regions Q_T6 and Q_T5 detected in the images at the times T6 and T5 in which the captured region A1 is captured, it is decided that the persons indicated by the regions are an identical person.

When it is decided that an identical person is present in an overlapping manner in terms of time or different persons are present in an overlapping manner in terms of place (step S304; Yes), the grouping unit 108 decides that the persons indicated by the regions are not an identical person (step S303).

For example, as illustrated in FIGS. 2 and 9, in the captured region A1 at the time T4, most of the region Q_T4 is located behind the region P_T4 and is hidden behind the region P_T4 when viewed from a capturing direction. In such a case, in the step S201, a fact that the region Q_T4 is a region of a person may not be able to be detected. In this case, persons detected in the images at the times T5 and T4 are persons in the regions P_T5, P_T4, and Q_T5.

In this case, for example, when poses of the person in the region P_T5 and the person in the region Q_T5 at the time T5 are similar, and the like, a similarity degree with a pose feature value of a person in a region in false combination different from a region of an actual person may be equal to or more than the first reference value.

For example, that is the time when a similarity degree between both of pose feature values of the persons in the regions P_T5 and Q_T5 and a pose feature value of the person in the region P_T4 is equal to or more than the first reference value. At this time, it is decided that the person in the region P_T4 is an identical person to the person P in the region P_T5 and is an identical person to the person Q in the region Q_T5, and thus the different persons P and Q are present in an overlapping manner at a place indicated by the region P_T4. In other words, the different persons are present in an overlapping manner in terms of place.

Alternatively, most of the region Q_T4 is hidden behind the region P_T4, and thus a pose of the person in the region Q_T4 may not be detected as an actual correct pose in the step S203.

Also, in this case, when poses of the person in the region P_T5 and the person in the region Q_T5 at the time T5 are similar, and the like, a similarity degree with a pose feature value of a person in a region in false combination different from a region of an actual person may be equal to or more than the first reference value.

For example, a similarity degree between a pose feature value of the person in the region P_T5 and both of pose feature values of the persons in the regions P_T4 and Q_T4 may be equal to or more than the first reference value. At this time, it is decided that the persons in the regions P_T4 and Q_T4 are an identical person to the person P in the region P_T5, and thus the identical person P is present in an overlapping manner at the time T4. In other words, the identical person is present in an overlapping manner in terms of time.

Further, for example, a similarity degree between a pose feature value of the person in the region Q_T5 and both of pose feature values of the persons in the regions P_T4 and Q_T4 may also be equal to or more than the first reference value. At this time, it is decided that the persons in the regions P_T4 and Q_T4 are an identical person to the person Q in the region Q_T5, and thus the identical person Q is present in an overlapping manner at the time T4.

In this way, by deciding identity of persons with not only the condition A but also the conditions B and C, a person detected in an image can be prevented from being mistakenly regarded as an identical person to a person different from an actual person.

Note that, a case where an error occurs in a decision of identity of persons is not limited to a case where a region and a pose of a person cannot be correctly detected due to the person hidden behind another person, and is also a case (not illustrated) where a region and a pose of a person cannot be correctly detected due to the person hidden behind a pillar, and the like.

The grouping unit 108 combines regions of persons decided as an identical person into a group (step S306).

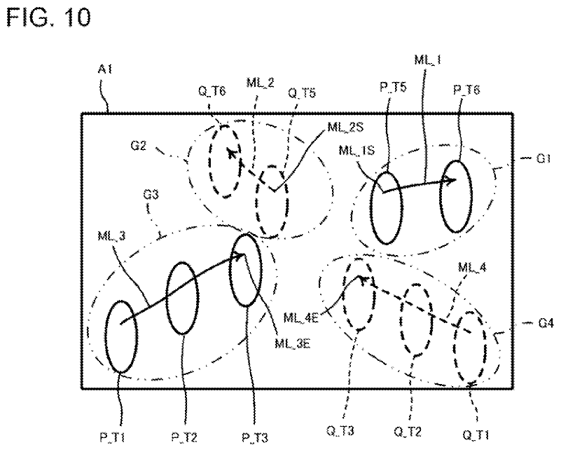

Specifically, for example, FIG. 10 illustrates an example in which persons detected in the images at the times T1 to T6 in which the captured region A1 is captured are combined into a group.

As illustrated in FIG. 10, for the regions P_T6, P_T5, Q_T6, and Q_T5 of the persons detected in the images at the times T6 and T5 in which the captured region A1 is captured, the grouping unit 108 causes the regions P_T6 and P_T5 to belong to a group G1 indicating an image of an identical person. Further, the grouping unit 108 causes the regions Q_T6 and Q_T5 to belong to a group G2 indicating an image of an identical person.

The grouping unit 108 performs the processing in the steps S302 to S306 on each combination of images continuous in time series among the images at the times T1 to T6 (loop C; step S301). In this way, as illustrated in FIG. 10, the persons detected in the images at the times T1 to T6 are divided into groups G1 to G4.

FIG. 10 illustrates an example in which the persons detected in the images at the times T1 to T6 in which the captured region A1 is captured are combined into a group. As described above, the regions P_T6 and P_T5 are combined into the group GT, and the regions Q_T6 and Q_T5 are combined into the group G2. Further, the regions P_T1 to P_T3 are combined into a group G3, and the regions Q_T1 to Q_T3 are combined into a group G4.

In this way, the grouping unit 108 ends the grouping processing (step S106), and the processing returns to the image analysis processing illustrated in FIG. 4.

As illustrated in FIG. 4, the grouping unit 108 generates a flow line of each of the groups GT to G4 (step S107).

For example, as illustrated in FIG. 10, flow lines ML_1 to ML_4 that smoothly connect predetermined places (for example, a place associated with a center of shoulders) in a region of a person belonging to each of the groups G1 to G4 are generated. A direction indicated by an arrow of the flow lines ML_1 to ML_4 is a movement direction in time series. For example, in the group G1, the flow line ML_1 that connects the regions P_T5 to P_T6 is generated. Further, it is clear from the arrow of the flow line ML_1 that the person indicated by the region belonging to the group G1 is moving slightly obliquely upward and also in a substantially right direction in the image.

FIG. 5 is referred again.

The coupling unit 109 decides whether a disconnected flow line is included in the flow lines ML_1 to ML_4 generated in the step S107 (step S108).

For example, with reference to FIG. 10, an end portion ML_1S of the flow line ML_1 is associated with a position of the person indicated by the region P_T5 and is located inside the captured region A1. Therefore, the flow line ML_1 is a disconnected flow line.

Similarly, all end portions of an end portion ML_2S of the flow line ML_2, an end portion ML_3E of the flow line ML_3, and an end portion ML_4E of the flow line ML_4 are also located inside the captured region A1. Therefore, all of the flow lines ML_2 to 4 are disconnected flow lines.

In this way, in the example illustrated in FIG. 10, all of the flow lines ML_1 to ML_4 are disconnected flow lines, and the coupling unit 109 decides that the disconnected flow line is included.

When it is decided that a disconnected flow line is not included (step S108; No), the detection unit 103 and the decision unit 104 perform the processing in the steps S103 to S110 on a next captured region (step S102; loop A).

When it is decided that a disconnected flow line is included (step S108; Yes), the coupling unit 109 repeatedly performs coupling processing (step S110) on the disconnected flow lines ML_1 to ML_4 (step S109; loop D).

Specifically, in the coupling processing (step S110), the coupling unit 109 decides whether the conditions A to G described above are satisfied for each combination of the disconnected flow lines ML_1 to ML_4. Then, when the conditions A to G are satisfied, the coupling unit 109 merges the groups, and also couples the end portions of the flow lines between the merged groups.

Herein, in the example in FIG. 10, the end portions ML_1S and ML_2S are based on the image at the common time T5, and the end portions ML_3E and ML_4E are based on the image at the common time T3. Since it is impossible that an identical person is captured in an overlapping manner in an image at a common time, processing of merging and coupling does not need to be performed on a combination of flow lines including end portions based on an image at a common time.

Thus, in the example in FIG. 10, a combination of the flow lines ML_1 to ML_4 to be a processing target in the loop D (step S109) is a combination of flow lines including the end portions ML_1S, ML_2S, ML_3E, and ML_4E included in images at different times. In other words, a combination of flow lines to be a processing target in the loop D (step S109) is a set of the flow line ML_1 and the flow line ML_3, a set of the flow line ML_1 and the flow line ML_4, a set of the flow line ML_2 and the flow line ML_3, and a set of the flow line ML_2 and the flow line ML_4.

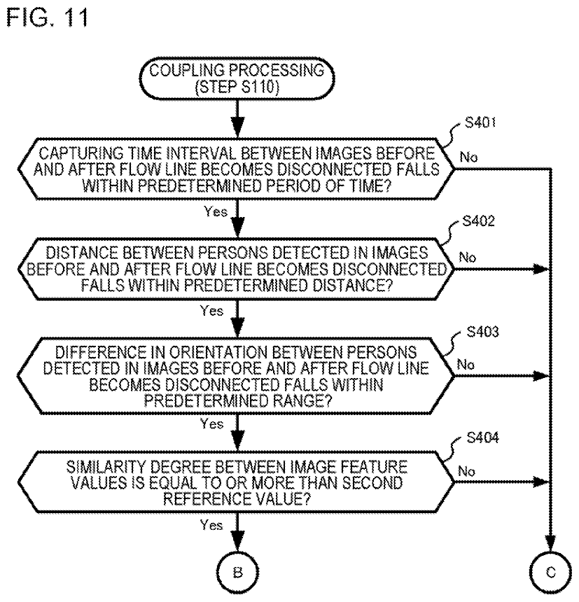

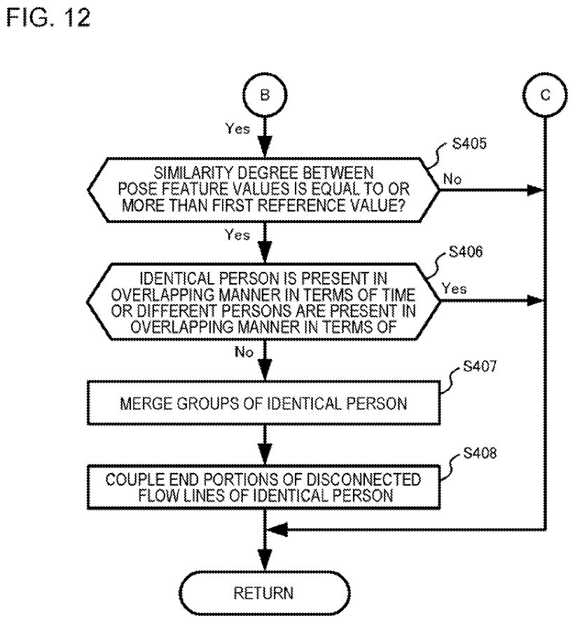

FIGS. 11 and 12 are a flowchart illustrating details of the coupling processing (step S110).

As illustrated in FIG. 11, the coupling unit 109 decides whether a capturing time interval between images before and after the flow lines ML_1 to ML_4 become disconnected falls within a predetermined period of time (step S401). The decision processing related to a disconnected capturing time interval in the step S401 corresponds to a decision about whether the condition D described above is satisfied.

Herein, a case where a flow line of an identical person becomes disconnected is a case where a person is hidden behind a fixed object such as a pillar, a case where a person is hidden behind a moving body such as a person, and the like, as described above. A capturing time interval between images before and after a flow line becomes disconnected is associated with a period of time during which a person passes behind a fixed object or a person when viewed from the camera 101a. Thus, a period of time associated with a period of time during which a person passes behind a fixed object or another person may be generally predetermined for the predetermined period of time.

In this way, when the capturing time interval between the images before and after the flow lines ML_1 to ML_4 become disconnected does not fall within a predetermined period of time, it can be decided that persons detected from both of the images are not an identical person. Further, when the capturing time interval falls within the predetermined period of time, it can be decided that there is a possibility that the persons detected from both of the images are an identical person.

In the example illustrated in FIG. 10, the number of disconnected images is one image in all of the combinations of the flow lines ML_1 to ML_4. Thus, when the predetermined period of time is determined as three images, for example, the coupling unit 109 decides that the capturing time interval between the images before and after the flow lines ML_1 to ML_4 become disconnected falls within the predetermined period of time for each combination of the flow lines ML_1 to ML_4.

Note that, a cause of a flow line becoming disconnected may be estimated, and a different predetermined period of time in response to the estimated cause may be determined. For example, as described above, in a case where a person is hidden behind a fixed object and a case where a person is hidden behind a moving body, a time interval of a flow line becoming disconnected is conceivably shorter in the case where the flow line becomes disconnected due to the latter case where both are moving than the former case. In this case, the cause of the flow line becoming disconnected may be estimated by obtaining a position of the fixed object in advance from an image and deciding whether the flow line becomes disconnected near the fixed object from the image.

FIG. 11 is referred again.

When the capturing time interval falls within the predetermined period of time (step S401; Yes), the coupling unit 109 decides whether a distance between the persons detected in the images before and after the flow lines ML_1 to ML_4 become disconnected falls within a predetermined distance (step S402). The decision processing related to a disconnected distance in the step S402 corresponds to a decision about whether the condition E described above is satisfied.

Herein, a distance in which a person generally moves within the predetermined period of time described above may be adopted for the predetermined distance. For example, when the cameras 101a to 101b capture N image/sec and the predetermined period of time is determined as three images, the predetermined distance may be determined in response to a distance in which a person moves during 3/N[sec]. Herein, the distance in which a person moves during a fixed period of time may be determined based on a general walking velocity (for example, 5 km/hour) or a velocity faster than that.

In this way, when the distance between the persons detected in the images before and after the flow lines ML_1 to ML_4 become disconnected does not fall within the predetermined distance, it can be decided that the persons are not an identical person. Further, when the distance falls within the predetermined distance, it can be decided that there is a possibility that the persons are an identical person.

In the example in FIG. 10, it is assumed that both of a distance between the end portion ML_3E and each of the end portions ML_1S and ML_2S and a distance between the end portion ML_4E and each of the end portions ML_1S and ML_2S fall within the predetermined distance. In this case, the coupling unit 109 decides that the distance between the persons detected in the images before and after the flow lines ML_1 to ML_4 become disconnected falls within the predetermined distance for each combination of the flow lines ML_1 to ML_4.

FIG. 11 is referred again.

When the distance between the detected persons falls within the predetermined distance (step S402; Yes), the coupling unit 109 decides whether a difference in orientation between the persons detected in the images before and after the flow lines ML_1 to ML_4 become disconnected falls within a predetermined range (step S403). The decision processing related to an orientation of a person in the step S403 corresponds to a decision about whether the condition F described above is satisfied.

Herein, the orientation of a person can be estimated from, for example, whether a face region is included in an image, a direction of a line segment connecting both shoulders, and the like, and the condition F is particularly effective when identity of persons is decided in a case where flow lines cross each other due to the persons passing each other.

For example, a face region of a person who walks in a direction away from the camera 101a along a capturing direction of the camera 101a is not captured by the camera 101a. In contrast, a face region of a person who walks in a direction approaching the camera 101a along the capturing direction is captured by the camera 101a. In this way, an orientation of a person can be estimated from whether a face region is included in an image.

Further, for example, a line segment connecting both shoulders of a person (i.e., a person who moves upward or downward in the captured region A1) who moves along the capturing direction of the camera 101a faces in the substantially left-right direction of the captured region A1. In contrast, a line segment connecting both shoulders of a person (i.e., a person who moves leftward or rightward in the captured region A1) who moves in a direction orthogonal to the capturing direction of the camera 101a faces in the substantially up-down direction of the captured region A1. In this way, an orientation of a person can be estimated from a direction of a line segment connecting both shoulders.

Since a moving person rarely changes an orientation rapidly, there is a high possibility that the persons detected in the images before and after the flow lines ML_1 to ML_4 become disconnected are not an identical person when the persons greatly vary in orientation. Thus, when the difference in orientation between the persons detected in the images before and after the flow lines ML_1 to ML_4 become disconnected does not fall within the predetermined range, it can be decided that the persons are not an identical person. Further, when the difference in orientation between the persons falls within the predetermined range, it can be decided that there is a possibility that the persons are an identical person.

In the example in FIG. 10, the flow lines ML_1 and ML_3 are flow lines of persons who move substantially upward to the right in the captured region A1. The flow lines ML_2 and ML_4 are flow lines of persons who move substantially upward to the left in the captured region A1. Thus, for the persons of the flow lines ML_1 to ML_4, a face region is not captured, or is relatively small even when the face region is captured, and thus it is often difficult to estimate an orientation of the person from the face region.

Further, a direction of a line segment connecting both shoulders does not also vary in angle between the persons of the flow lines ML_1 and ML_3 and the persons of the flow lines ML_2 and ML_4 in contrast to a case where line segments are orthogonal to each other. Thus, the coupling unit 109 decides that the difference in orientation between the persons detected in the images before and after the flow lines ML_1 to ML_4 become disconnected falls within the predetermined range for each combination of the flow lines ML_1 to ML_4.

FIG. 11 is referred again.

When the difference in orientation between the detected persons falls within the predetermined range (step S403; Yes), the coupling unit 109 decides whether a similarity degree between image feature values of the persons detected in the images before and after the flow lines ML_1 to ML_4 become disconnected is equal to or more than the second reference value (step S404). The decision processing related to an image feature value in the step S404 corresponds to a decision about whether the condition G described above is satisfied.

Herein, there is a high possibility that images of persons having greatly different image feature values are images of different persons. Thus, when a similarity degree between image feature values of persons is not equal to or more than the second reference value, it can be decided that the persons are not an identical person. Further, when a similarity degree between image feature values of persons is equal to or more than the second reference value, it can be decided that there is a possibility that the persons are an identical person.

In the example in FIG. 10, it is assumed that a similarity degree between image feature values of the persons detected in the images before and after the flow lines ML_1 to ML_4 become disconnected is equal to or more than the second reference value in each combination of the regions P_T3, P_T5, Q_T3, and Q_T5 associated with each combination of the flow lines ML_1 to ML_4.

FIG. 11 is referred again.

When the coupling unit 109 decides that the similarity degree between the image feature values is equal to or more than the second reference value (step S404; Yes), as illustrated in FIG. 12, the coupling unit 109 decides whether a similarity degree between pose feature values of the persons detected in the images before and after the flow lines ML_1 to ML_4 become disconnected is equal to or more than the first reference value (step S405). The decision processing related to a pose feature value in the step S405 corresponds to a decision about whether the condition A described above is satisfied.

As described above, a pose of a moving person rarely changes greatly in a short time. Thus, in the example in FIG. 10, for the set of the flow line ML_1 and the flow line ML_3 and the set of the flow line ML_2 and the flow line ML_4, the coupling unit 109 decides that the similarity degree between the pose feature values of the persons is equal to or more than the first reference value. Further, for a set of the other flow lines, the coupling unit 109 decides that the similarity degree between the pose feature values of the persons is not equal to or more than the first reference value.

FIG. 12 is referred again.

When the coupling unit 109 decides that the similarity degree between the pose feature values is equal to or more than the first reference value (step S405; Yes), the coupling unit 109 decides whether an identical person is present in an overlapping manner in terms of time or different persons are present in an overlapping manner in terms of place (step S406). The decision processing related to overlapping of an identical person in the step S406 corresponds to a decision about whether the conditions B and C described above are satisfied.

In the example in FIG. 10, for the set of the flow line ML_1 and the flow line Ml_3 and the set of the flow line ML_2 and the flow line ML_4, the coupling unit 109 decides that an identical person is not present in an overlapping manner in terms of time and different persons are not present in an overlapping manner in terms of place.

However, in the step S406, whether an identical person is present in an overlapping manner in terms of time or whether different persons are present in an overlapping manner in terms of place is decided for all regions included in each group, i.e., for each of the entire flow lines.

In contrast to the example in FIG. 10, it is assumed that flow lines A, B, and C each include an end portion at times TA, TB, and TC, the time TC is later than the time TB, and the time TB is later than the time TA. Further, it is assumed that the conditions D to G are satisfied in a combination of both of a set of the flow lines A and B and a set of the flow lines B and C.

In the example, when the condition A is satisfied in the combination of both of the set of the flow lines A and B and the set of the flow lines B and C, the flow line A is coupled to both of the flow lines B and C, and an identical person is present in an overlapping manner in terms of time after the time TC. In such a case, in the step S406, it is decided that an identical person is present in an overlapping manner in terms of time, based on each of the entire flow lines.

When the coupling unit 109 decides that an identical person is not present in an overlapping manner in terms of time and different persons are not present in an overlapping manner in terms of place (step S406; No), the coupling unit 109 decides that the combination of the flow lines ML_1 to ML_4 to be a processing target are acquired from an identical person.

Thus, the coupling unit 109 merges groups of the regions constituting the flow lines ML_1 to ML_4 of the identical person, i.e., groups of the identical person (step S407). Furthermore, the coupling unit 109 couples end portions of the disconnected flow lines ML_1 to ML_4 of the identical person (step S408). After the processing in the step S408 is performed, the coupling unit 109 ends the coupling processing (step S110).

In the example illustrated in FIG. 10, the set of the flow line ML_1 and the flow line ML_3 and the set of the flow line ML_2 and the flow line ML_4 satisfy the conditions A to G as described above. Thus, in the step S407, the group G1 and the group G3 are merged as a group related to the person P. The group G2 and the group G4 are merged as a group related to the person Q.

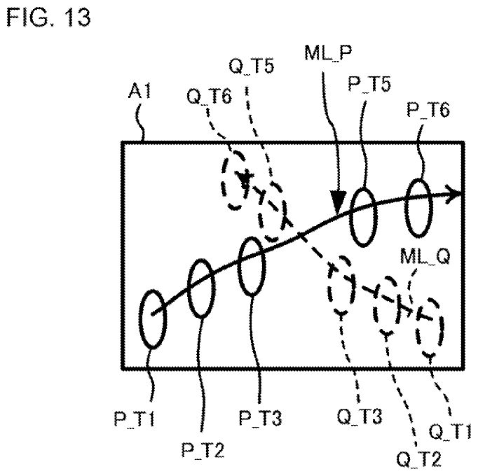

Further, in the step S408, as illustrated in FIG. 13, the flow line ML_1 and the flow line ML_3 are coupled, and thus a flow line ML_P related to the person P is generated. The flow line ML_2 and the flow line ML_4 are coupled, and thus a flow line ML_Q related to the person Q is generated.

FIGS. 11 and 12 are referred again.

When a decision different from that as described above is made in the steps S401 to S406, the coupling unit 109 ends the coupling processing (step S110).

In other words, with reference to FIG. 11, when the coupling unit 109 decides that the capturing time interval does not fall within the predetermined period of time (step S401; No), when the coupling unit 109 decides that the distance between the persons does not fall within the predetermined distance (step S402; No), when the coupling unit 109 decides that the difference in orientation between the persons does not fall within the predetermined range (step S403; No), or when the coupling unit 109 decides that the similarity degree between the image feature values is not equal to or more than the second reference value (step S404; No), the coupling unit 109 ends the coupling processing (step S110).

With reference to FIG. 12, when the coupling unit 109 decides that the similarity degree between the pose feature values is not equal to or more than the first reference value (step S405; No), or when the coupling unit 109 decides that an identical person is present in an overlapping manner in terms of time or different persons are present in an overlapping manner in terms of place (step S406; Yes), the coupling unit 109 ends the coupling processing (step S110).

When the coupling processing (step S110) ends, the processing returns to the image analysis processing illustrated in FIG. 5, the detection unit 103 repeats the processing in the loop A (step S102). In the present example embodiment, the processing in the steps S103 to S110 is further performed on the captured region A2.

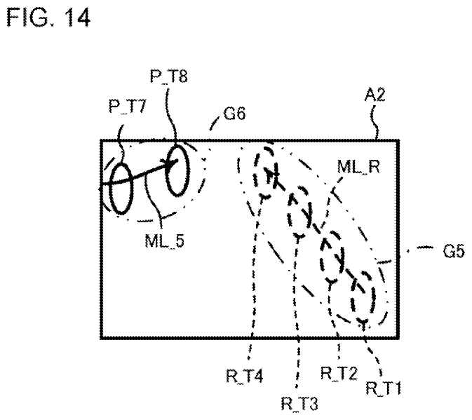

Based on the images (see FIGS. 2 and 6) at the times T1 to T8 of the captured region A2, for example, as illustrated in FIG. 14, regions R_T1 to R_T4 are combined into a group G5 related to a person R, and a flow line ML_R related to the person R is generated. Further, regions P_T7 to P_T8 are combined into a group G6, and a flow line ML_5 is generated.

When the processing in the steps S103 to S110 is performed on all of the captured regions A1 and A2, the loop A (step S102) ends as illustrated in FIG. 5. Then, the coupling unit 109 couples the flow lines ML_P, ML_Q, ML_5, and ML_R between the different captured regions A1 and A2 (step S111).

Also, herein, since it is impossible that an identical person is captured in an overlapping manner in an image at a common time, whether a combination of flow lines including end portions included in images at different times is flow lines of an identical person is decided based on an image feature value. The combination of the flow lines to be a processing target in the step S111 is a set of the flow line ML_P and the flow line ML_5 and a set of the flow line ML_Q and the flow line ML_5 in a case of the flow lines ML_P, ML_Q, ML_5, and ML_R.

For example, when a similarity degree between image feature values of regions being end portions of a set of flow lines is equal to or more than the second reference value, the coupling unit 109 decides that the flow lines are acquired from an identical person, and merges groups of the regions constituting the flow lines and also couples the end portions of the flow lines. Further, when the similarity degree between the image feature values is not equal to or more than the second reference value, the coupling unit 109 decides that the flow lines are not acquired from an identical person, and does not merge the groups and also does not couple the flow lines.

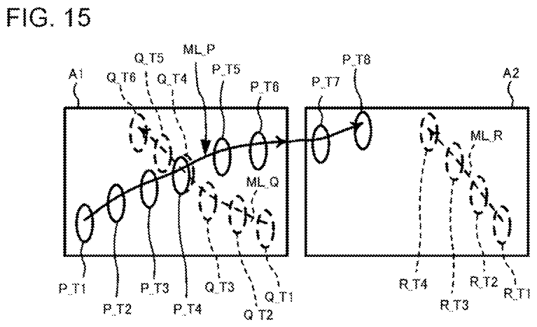

By performing the step S111, as illustrated in FIG. 15, the flow lines in the different captured regions A1 and A2 are coupled. FIG. 15 illustrates an example in which the flow line ML_P acquired by coupling the flow line ML_5 illustrated in FIG. 14 to the flow line ML_P illustrated in FIG. 13 is generated as a flow line related to the person P. Further, the flow line ML_P is connected between the captured region A1 and the captured region A2 by a flow line that smoothly connects the flow line ML_P illustrated in FIG. 13 and the flow line ML_5.

Note that, also in the step S111, merging of groups and coupling of flow lines may be performed based on whether an appropriate combination of the conditions A to G is satisfied.

FIG. 5 is referred again.

The identification image output unit 105 outputs identification image information based on a result of the decision by the decision unit 104 (step S112), and ends the image analysis processing.

An image indicated by the identification image information is, for example, an image in which, with flow lines of persons detected in a plurality of images as identification information, the identification information is associated with the person indicated in each of the images by connecting regions of the persons by the flow lines (see FIG. 15). Further, for example, an image indicated by the identification image information is an image in which, with a number, a symbol, a mark (for example, P, Q, R), and the like for identifying a person as identification information, the identification information is associated with a region of a person indicated in the image.

Note that, herein, an example in which a decision result of identity of persons detected in a plurality of images continuous in time series is output as identification image information is exemplified, but a decision result of identity may be output by an appropriate method without being limited to an image, and may be used for various types of processing such as analysis processing related to movement of a person.

As described above, according to the present example embodiment, a person and a pose of the person are detected in each of a plurality of images continuous in time series, and identity of persons detected in images different from each other is decided by using the detected pose of the person. In this way, in a case where identity of persons is decided from an image feature value, even when it is difficult to track a person due to a flow line of the person becoming disconnected and the like, the identity of the persons can be decided. Therefore, an identical person can be accurately determined in a plurality of images continuous in time series.

According to the present example embodiment, identity of persons detected in the images different from each other is decided by using a pose of a person detected in each image captured within a predetermined period of time in time series among the plurality of images. In this way, the identity of the persons can be more accurately decided. Therefore, an identical person can be more accurately determined in a plurality of images continuous in time series.

According to the present example embodiment, identity of persons detected in the images different from each other is decided by using a pose of a person within a predetermined distance among persons detected in each of the plurality of images. In this way, the identity of the persons can be more accurately decided. Therefore, an identical person can be more accurately determined in a plurality of images continuous in time series.

According to the present example embodiment, an orientation of a person detected in each of the plurality of images is obtained. Then, identity of persons detected in the images different from each other is decided by using a pose of a person in which a difference in the obtained orientation falls within a predetermined range among persons detected in each of the plurality of images. In this way, the identity of the persons can be more accurately decided. Therefore, an identical person can be more accurately determined in a plurality of images continuous in time series.

According to the present example embodiment, a pose feature value of the person is obtained by using a detected pose of a person. Then, identity of persons detected in the images different from each other is decided based on whether a similarity degree between the obtained pose feature values is equal to or more than a predetermined reference value. In this way, in a case where identity of persons is decided from an image feature value, even when it is difficult to track a person due to a flow line of the person becoming disconnected and the like, the identity of the persons can be decided. Therefore, an identical person can be accurately determined in a plurality of images continuous in time series.

According to the present example embodiment, in a case where a similarity degree between the obtained pose feature values is equal to or more than the predetermined reference value, it is decided that persons detected in the images different from each other are not an identical person when an identical person is present in an overlapping manner in terms of time or different persons are present in an overlapping manner in terms of place. In this way, the identity of the persons can be prevented from being decided in a state that is unlikely to actually occur. Therefore, an identical person can be more accurately determined in a plurality of images continuous in time series.

According to the present example embodiment, in a case where a similarity degree between the obtained pose feature values is equal to or more than the predetermined reference value, it is decided that persons detected in the images different from each other are an identical person when an identical person is not present in an overlapping manner in terms of time or different persons are not present in an overlapping manner in terms of place. In this way, the identity of the persons can be prevented from being decided in a state that is unlikely to actually occur. Therefore, an identical person can be more accurately determined in a plurality of images continuous in time series.

According to the present example embodiment, an image in which information that identifies a person in a plurality of images is associated with a person indicated in each of the images is output based on a result of a decision related to identity of detected persons. By referring to such an image, a user can easily understand movement of the person by viewing the image. Therefore, the user can easily understand movement of the person.

Although the example embodiments and the modification examples of the present invention have been described above, the present invention is not limited to them. For example, the present invention also includes a manner acquired by combining a part or the whole of the example embodiments and the modification examples described above, and a manner acquired by appropriately adding modifications to the manner.

One means or the whole means of the above-described example embodiments may also be described in supplementary notes below, which are not limited thereto.

1. An image analysis apparatus, including:
an image acquisition means for acquiring a plurality of images continuous in time series;
a detection means for detecting a person and a pose of the person in each of the plurality of images; and
a decision means for deciding identity of persons detected in images different from each other by using the detected pose of the person.
   2. The image analysis apparatus according to supplementary note 1, wherein
the decision means decides identity of persons detected in the images different from each other by using a pose of a person detected in each image captured within a predetermined period of time in time series among the plurality of images.
   3. The image analysis apparatus according to supplementary note 1 or 2, wherein
the decision means decides identity of persons detected in the images different from each other by using a pose of a person within a predetermined distance among persons detected in each of the plurality of images.
   4. The image analysis apparatus according to any one of supplementary notes 1 to 3, wherein
the decision means obtains an orientation of a person detected in each of the plurality of images, and decides identity of persons detected in the images different from each other by using a pose of a person in which a difference in the obtained orientation falls within a predetermined range among persons detected in each of the plurality of images.
   5. The image analysis apparatus according to any one of supplementary notes 1 to 4, wherein
the decision means obtains an image feature value of a person detected in each of the plurality of images, and decides identity of persons detected in the images different from each other, based on whether a similarity degree between the obtained image feature values is equal to or more than a predetermined reference value, among persons detected in each of the plurality of images.
   6. The image analysis apparatus according to any one of supplementary notes 1 to 5, wherein
the decision means includes
   a feature value acquisition means for obtaining, by using the detected pose of the person, a pose feature value of the person, and
   a determination means for deciding identity of persons detected in the images different from each other, based on whether a similarity degree between the obtained pose feature values is equal to or more than a predetermined reference value.
      7. The image analysis apparatus according to supplementary note 6, wherein
the determination means decides that persons detected in the images different from each other are not an identical person when an identical person is present in an overlapping manner in terms of time or different persons are present in an overlapping manner in terms of place in a case where a similarity degree between the obtained pose feature values is equal to or more than a predetermined reference value.
   8. The image analysis apparatus according to supplementary note 6 or 7, wherein
the determination means decides that persons detected in the images different from each other are an identical person when an identical person is not present in an overlapping manner in terms of time and different persons are not present in an overlapping manner in terms of place in a case where a similarity degree between the obtained pose feature values is equal to or more than a predetermined reference value.
   9. The image analysis apparatus according to any one of supplementary notes 1 to 8, further including
an identification image output means for outputting an image in which information for identifying a person detected in each of the plurality of images is associated with the person, based on a result of a decision by the decision means.
   10. An image analysis system, including:
one or a plurality of capturing means; and
the image analysis apparatus according to any one of supplementary notes 1 to 9.

11. An image analysis method, including:
by a computer
acquiring a plurality of images continuous in time series;
detecting a person and a pose of the person in each of the plurality of images; and
deciding identity of persons between images different from each other by using the
detected pose of the person.
   12. A program causing a computer to execute:
acquiring a plurality of images continuous in time series;
detecting a person and a pose of the person in each of the plurality of images; and
deciding identity of persons between images different from each other by using the detected pose of the person.
100 Image analysis apparatus
101a, 101b Camera
102 Image acquisition unit
103 Detection unit
104 Decision unit
105 Identification image output unit
106 Feature value acquisition unit
107 Determination unit
108 Grouping unit
109 Coupling unit

What is claimed is:

1 An image analysis apparatus, comprising:
at least one memory configured to store instructions; and
at least one processor configured to execute the instructions to perform operations comprising:
acquiring a plurality of images continuous in time series;
detecting a person and a pose of the person in each of the plurality of images; and
deciding identity of persons detected in images different from each other by using the detected pose of the person.

2. The image analysis apparatus according to claim 1, wherein
the deciding identity of persons includes deciding identity of persons detected in the images different from each other by using a pose of a person detected in each image captured within a predetermined period of time in time series among the plurality of images.

3. The image analysis apparatus according to claim 1, wherein
the deciding identity of persons includes deciding identity of persons detected in the images different from each other by using a pose of a person within a predetermined distance among persons detected in each of the plurality of images.

4. The image analysis apparatus according to claim 1, wherein
the deciding identity of persons includes obtaining an orientation of a person detected in each of the plurality of images, and decides identity of persons detected in the images different from each other by using a pose of a person in which a difference in the obtained orientation falls within a predetermined range among persons detected in each of the plurality of images.

5. The image analysis apparatus according to claim 1, wherein
the deciding identity of persons includes obtaining an image feature value of a person detected in each of the plurality of images, and decides identity of persons detected in the images different from each other, based on whether a similarity degree between the obtained image feature values is equal to or more than a predetermined reference value, among persons detected in each of the plurality of images.

6. The image analysis apparatus according to claim 1, wherein
the deciding identity of persons includes
obtaining, by using the detected pose of the person, a pose feature value of the person, and
deciding identity of persons detected in the images different from each other, based on whether a similarity degree between the obtained pose feature values is equal to or more than a predetermined reference value.

7. The image analysis apparatus according to claim 6, wherein
the deciding identity of persons includes deciding that persons detected in the images different from each other are not an identical person when an identical person is present in an overlapping manner in terms of time or different persons are present in an overlapping manner in terms of place in a case where a similarity degree between the obtained pose feature values is equal to or more than a predetermined reference value.

8. The image analysis apparatus according to claim 6, wherein
the deciding identity of persons includes deciding that persons detected in the images different from each other are an identical person when an identical person is not present in an overlapping manner in terms of time and different persons are not present in an overlapping manner in terms of place in a case where a similarity degree between the obtained pose feature values is equal to or more than a predetermined reference value.

9. The image analysis apparatus according to claim 1, further comprising
outputting an image in which information for identifying a person detected in each of the plurality of images is associated with the person, based on a result of a decision by the deciding identity of persons.

10. (canceled)

11. An image analysis method, comprising:
by a computer
acquiring a plurality of images continuous in time series;
detecting a person and a pose of the person in each of the plurality of images; and
deciding identity of persons between images different from each other by using the detected pose of the person.

12. A non-transitory storage medium storing a program causing a computer to execute:
acquiring a plurality of images continuous in time series;
detecting a person and a pose of the person in each of the plurality of images; and
deciding identity of persons between images different from each other by using the detected pose of the person.
